(19) United States
(12) Patent Application Publication
(10) Pub. No.: US 2025/0091254 A1
(43) Pub. Date: Mar. 20, 2025

(54) THERMOPLASTIC IMPREGNATION OF LARGE TOW TEXTILE GRADE CARBON FIBER

(71) Applicant: University of Tennessee Research Foundation, Knoxville, TN (US)

(72) Inventors: Uday Kumar Vasant Vaidya, Birmingham, AL (US); Joseph Michael Gauspohl, Powell, TN (US); Saurabh Prakash Pethe, Knoxville, TN (US); George Ervin Husman Ervin Husman, Bolivia, NC (US)

(73) Assignee: University of Tennessee Research Foundation, Knoxville, TN (US)

(21) Appl. No.: 18/566,842

(22) PCT Filed: Jun. 6, 2022
(86) PCT No.: PCT/US2022/032315

§ 371 Date: Dec. 4, 2023

Related U.S. Application Data
(60) Provisional application No. 63/197,111, filed on Jun. 4, 2021.

(51) Int. Cl. B29B 11/16; B29B 11/10; B29K 307/04

(52) U.S. Cl. CPC B29B 11/16; B29B 11/10; B29K 2307/04

(57) ABSTRACT

A process of preparing carbon fiber reinforced polymer (CFRP) intermediate products is described wherein carbon fiber tows, such >50 K or 100K textile grade carbon fiber tows, are spread and contacted with a sheet of molten polymer resin. Also described is a system for preparing CFRP intermediate products, such as continuous tapes, and the CFRP intermediate products themselves.

### RELATED APPLICATIONS

The presently disclosed subject matter claims the benefit of U.S. Provisional Patent Application Ser. No. 63/197,111, filed Jun. 4, 2021; the disclosure of which is incorporated herein by reference in its entirety.

### GOVERNMENT INTEREST

This invention was made with government support under grant number DE-EE0006926 awarded by the Department of Energy. The government has certain rights in the invention.

### TECHNICAL FIELD

The presently disclosed subject matter relates, in some embodiments, to methods of impregnating fiber tows, such as large (e.g., >50 K, >100 K) carbon fiber tows, with polymers, as well as to related systems and carbon fiber reinforced intermediates.

### BACKGROUND

Carbon fiber is used in fiber-reinforced polymer composite materials in a wide array of consumer, industrial, and military applications. Advantages of carbon fiber for use in these applications include its high strength, high stiffness, and light weight or low density. Unfortunately, carbon fiber is relatively expensive with respect to other commonly used structural materials, such as steel and aluminum, limiting its use in many applications.

In many applications of carbon fiber-reinforced polymer (CFRP) composites, the carbon fiber and polymer, whether thermoplastic or thermosetting polymer, are combined using various processes to manufacture carbon fiber intermediate, value-added products that are then used in subsequent CFRP composite product manufacturing. The production of these carbon fiber intermediate, value-added products, such as carbon fiber prepreg tapes and carbon fiber compounded thermoplastic pellets, can add substantial costs, further limiting use of carbon fiber in many applications. For example, in many cases, the cost of these carbon fiber intermediate products are more than two times the cost of the raw materials, i.e., the carbon fiber and polymer, used to produce them. These additive costs are a reason that many product manufacturers do not take advantage of the higher performance properties of CFRP composites and instead use lower cost, lower performance materials.

Accordingly, there is an ongoing need for processes and systems that can produce carbon fiber intermediates, particularly those that can provide the intermediates at lower cost.

### SUMMARY

In some embodiments, the presently disclosed subject matter provides a process for preparing a carbon fiber reinforced polymer (CFRP) intermediate product, wherein the CFRP intermediate product comprises carbon fiber and a polymeric matrix, the process comprising: (a) spreading a carbon fiber tow to provide a spread carbon fiber tow; (b) heating the spread carbon fiber tow to provide a heated spread carbon fiber tow; (c) extruding a molten polymer resin through a first impregnation die, wherein said molten polymer resin is a molten thermoplastic or melt-processable thermosetting polymer resin corresponding to the polymeric matrix of the CFRP intermediate product, and wherein said first impregnation die comprises a chamber and an extrusion slit, wherein said first impregnation die is configured to extrude a sheet of molten polymer resin from said extrusion slit; (d) impregnating the heated spread carbon fiber tow with molten polymer resin, wherein said impregnating comprises contacting the heated spread carbon fiber tow with the sheet of molten polymer resin, thereby providing a polymer impregnated carbon fiber tow; and (e) cooling the polymer impregnated carbon fiber tow to provide a cooled, polymer impregnated carbon fiber.

In some embodiments, the carbon fiber tow comprises textile grade carbon fiber (TCF). In some embodiments, the carbon fiber tow comprises about 100,000 or more carbon fiber filaments, optionally about 300,000 or more carbon fiber filaments, further optionally about 300,000 to about 600,000 carbon fiber filaments or about 350,000 to about 450,000 carbon fiber filaments.

In some embodiments, prior to step (a), the carbon fiber tow is heated and/or tensioned. In some embodiments, prior to step (a), the carbon fiber tow is treated to eliminate a sizing agent or agents.

In some embodiments, step (a) comprises passing the carbon fiber tow under tension over and/or under a spreader roller, thereby spreading carbon fiber filaments in the carbon fiber tow and providing a spread carbon fiber tow. In some embodiments, the spreader roller is a curved bar. In some embodiments, heating the spread carbon fiber tow comprises heating the spread carbon fiber tow to about a melt temperature of the molten polymer resin corresponding to the polymeric matrix of the CFRP intermediate. In some embodiments, heating the spread carbon fiber tow comprises passing the spread carbon fiber tow over one or more heated bars or through an oven.

In some embodiments, the first impregnation die comprises a sheet or film extrusion die, optionally a coat hanger die. In some embodiments, the sheet of molten polymer resin and the heated spread carbon fiber tow have about the same width. In some embodiments, the extrusion slit is positioned in a curved end of the first impregnation die and the heated spread carbon fiber tow is conformed to said curved end during said impregnating step.

In some embodiments, contacting the heated spread carbon fiber tow with the sheet of molten polymer resin provides a semi-impregnated carbon fiber tow and step (d) further comprises mechanically contacting the semi-impregnated carbon fiber tow to provide the polymer impregnated carbon fiber tow, optionally wherein the mechanically contacting comprises passing the semi-impregnated carbon fiber tow through a series of pins to provide the polymer impregnated carbon fiber tow. In some embodiments, the series of pins is configured in a second impregnation die, optionally wherein said second impregnation die is heated to a melt temperature of the molten polymer resin. In some embodiments, the series of pins comprises a series of pin pairs and step (d) comprises passing the semi-impregnated carbon fiber tow over or under at least one pin of each pin pair in said series of pin pairs.

In some embodiments, the molten polymer resin comprises a resin corresponding to a thermoplastic polymer selected from the group comprising a polyolefin, a polyamide, a polyimide, a polyaryletherketone, a polysulfone, a polyarylene sulfide, and a polyurethane. In some embodiments, the molten polymer resin comprises a resin corresponding to a melt-processable thermoset polymer selected from the group comprising an epoxy, a polyimide, and a polyester.

In some embodiments, the cooling comprises air cooling. In some embodiments, the cooling is performed while maintaining the polymer impregnated carbon fiber tow in a tape or ribbon geometry. In some embodiments, the cooled, polymer impregnated carbon fiber is pulled through a puller device following step (e) to maintain a desired speed and/or tension.

In some embodiments, the process further comprises step (f), wherein step (f) comprises further processing the cooled, polymer impregnated carbon fiber, optionally wherein step (f) comprises feeding the cooled, polymer impregnated carbon fiber onto a spool or a tape winder or wherein step (f) comprises pelletizing or chopping the cooled, polymer impregnated carbon fiber. In some embodiments, the CFRP intermediate product comprises between about 30 weight % carbon fiber and about 70 weight % carbon fiber.

In some embodiments, the presently disclosed subject matter provides a CFRP intermediate product prepared according to a process comprising: (a) spreading a carbon fiber tow to provide a spread carbon fiber tow; (b) heating the spread carbon fiber tow to provide a heated spread carbon fiber tow; (c) extruding a molten polymer resin through a first impregnation die, wherein said molten polymer resin is a molten thermoplastic or melt-processable thermosetting polymer resin corresponding to the polymeric matrix of the CFRP intermediate product, and wherein said first impregnation die comprises a chamber and an extrusion slit, wherein said first impregnation die is configured to extrude a sheet of molten polymer resin from said extrusion slit; (d) impregnating the heated spread carbon fiber tow with molten polymer resin, wherein said impregnating comprises contacting the heated spread carbon fiber tow with the sheet of molten polymer resin, thereby providing a polymer impregnated carbon fiber tow; and (e) cooling the polymer impregnated carbon fiber tow to provide a cooled, polymer impregnated carbon fiber.

In some embodiments, the presently disclosed subject matter provides a system for preparing a CFRP intermediate product, wherein the CFRP intermediate product comprises carbon fiber and a polymeric matrix, said polymeric matrix comprising a thermoplastic polymeric matrix or a thermoset polymeric matrix of a melt-processable thermosetting polymer resin, said system comprising: (i) a carbon fiber tow feed roll; (ii) a fiber spreading stage configured to receive carbon fiber tow from the carbon fiber tow feed roll and spread said carbon fiber tow, optionally wherein the fiber spreading stage comprises a spreader roller configured to spread the carbon fiber tow to a desired width, further optionally wherein the spreader roller is a bowed spreader roller; (iii) a pre-heating stage configured to receive carbon fiber tow from the fiber spreading stage and to heat the carbon fiber tow to a temperature to match a melt temperature of a polymer resin corresponding to the polymeric matrix of the CFRP intermediate product; (iv) a first impregnation stage configured to receive carbon fiber tow from the pre-heating stage, said first impregnation stage comprising (1) a first impregnation die and (2) an extruder or a polymer resin feed tube, wherein said first impregnation die comprises a chamber and an extrusion slit, wherein said extruder or polymer resin feed tube is configured to supply molten polymer resin corresponding to the polymeric matrix of the CFRP intermediate product to the chamber of the first impregnation die and wherein the extrusion slit is configured to extrude a sheet of molten polymer resin onto a surface of carbon fiber tow received from the pre-heating stage; (v) an optional second impregnation stage configured to receive carbon fiber tow from the first impregnation stage, said second impregnation stage configured such that carbon fiber tow received from the first impregnation stage is mechanically contacted as it passes through the second impregnation stage, optionally wherein the second impregnation stage comprises a series of pins configured such that the carbon fiber tow passes over or under a plurality of pins in the series of pins, further optionally wherein said series of pins are heated or enclosed in a heated body; (vi) a cooling stage, positioned to receive polymer impregnated carbon fiber from the first or second impregnation stage, wherein the polymer impregnated carbon fiber is cooled; and (vii) an optional product processing stage, positioned to receive cooled polymer impregnated carbon fiber after it exits the cooling stage and wherein the cooled, polymer impregnated carbon fiber is processed into a desired form of the CFRP intermediate product.

In some embodiments, the system further comprises one or more tensioning roll configured between the carbon fiber tow feed roll and the fiber spreading stage. In some embodiments, the system further comprises one or more heated bars configured between the carbon fiber tow feed roll and the fiber spreading stage.

In some embodiments, the extrusion slit is positioned in an end of the first impregnation die having a curved outer surface and the first impregnation stage is configured so that carbon fiber tow passing through the first impregnation stage conforms to the curved outer surface. In some embodiments, the series of pins in the second impregnation stage comprises a series of pin pairs, and wherein carbon fiber tow received from the first impregnation stage passes over or under at least one pin of each of said series of pin pairs, optionally in a path comprising a least two different break angles.

In some embodiments, cooling stage (vi) comprises a series of at least two free-turning rollers through which polymer impregnated carbon fiber can be pulled. In some embodiments, cooling stage (vi) comprises one or more jet for directing cooled air or cooled water toward polymer impregnated carbon fiber. In some embodiments, cooling stage (vi) comprises a chamber through which polymer impregnated carbon fiber can be pulled, wherein the chamber comprises an inlet for cooled air, an inlet for a polymer impregnated carbon fiber tow, and an outlet for cooled, polymer impregnated carbon fiber. In some embodiments, cooling stage (vi) comprises a shaping die for forming a rod-shaped material from polymer impregnated carbon fiber.

In some embodiments, the system further comprises a puller, positioned between cooling stage (vi) and product processing stage (vii) through which cooled, polymer impregnated carbon fiber is pulled after it exits cooling stage (vi). In some embodiments, product processing stage (vii) comprises a winder, a spool or a tape winder. In some embodiments, product processing stage (vii) comprises a chopper and/or a pelletizer.

In some embodiments, the presently disclosed subject matter provides a CFRP intermediate product, wherein said CFRP comprises fully impregnated textile grade carbon fiber. In some embodiments, the CFRP intermediate product is a CFRP tape. In some embodiments, the CFRP intermediate product comprises a thermoplastic polymer matrix or a matrix formed from a melt-processable thermosetting polymer.

Accordingly, it is an object of the presently disclosed subject matter to provide methods and systems for impregnating fiber tows with polymer and the related impregnated fiber intermediate products, e.g., tapes.

An object of the presently disclosed subject matter having been stated hereinabove, and which is achieved in whole or in part by the presently disclosed subject matter, other objects will become evident as the description proceeds herein below.

### BRIEF DESCRIPTION OF THE DRAWINGS

FIG. 1 is a schematic diagram showing a system and process flow for thermoplastic polymer impregnation of fiber tows, such as textile-grade carbon fiber (TCF) tows.

FIG. 2 is a schematic sectional internal view of an impregnation die with a coat-hanger geometry used in the system and process of FIG. 1.

FIG. 3 is a schematic view of the first impregnation die extruding out thin sheet of molten polymer resin used in the system and process of FIG. 1.

FIG. 4A is a schematic showing a non-spread carbon fiber tow used in the system and process of FIG. 1.

FIG. 4B is a schematic showing a spread out carbon fiber tow used in the system and process of FIG. 1.

FIG. 5 is a schematic sectional side view showing the interaction between a spread carbon fiber tow and the impregnation die used in the system and process of FIG. 1.

FIG. 6 is a schematic sectional side view showing the interaction between a spread carbon fiber tow and a plurality of impregnation dies used in the system and process of FIG. 1.

FIG. 7 is a schematic showing the coordinate axes assigned to the tow.

FIG. 8 is a schematic showing a series of pins used in the system and process of FIG. 1.

FIG. 9 is a schematic of showing an individual pin pair of series of pins of FIG. 8.

FIG. 10 is a schematic showing a carbon fiber tow traversing through the series of pins of FIG. 8 and with break angles. Exemplary break angles in the pin pairs are described further in Table 2.

FIG. 11 is a photographic image showing a fully impregnated carbon fiber (CF) tow in a tape or ribbon geometry.

FIG. 12 is a schematic showing a tape winder placing the carbon fiber reinforced polymer intermediate tape product onto a spool.

### DETAILED DESCRIPTION

The presently disclosed subject matter will now be described more fully. The presently disclosed subject matter can, however, be embodied in different forms and should not be construed as limited to the embodiments set forth herein below and in the accompanying Examples. Rather, these embodiments are provided so that this disclosure will be thorough and complete, and will fully convey the scope of the embodiments to those skilled in the art.

All references listed herein, including but not limited to all patents, patent applications and publications thereof, and scientific journal articles, are incorporated herein by reference in their entireties to the extent that they supplement, explain, provide a background for, or teach methodology, techniques, and/or compositions employed herein.

### I. Definitions

While the following terms are believed to be well understood by one of ordinary skill in the art, the following definitions are set forth to facilitate explanation of the presently disclosed subject matter.

Unless defined otherwise, all technical and scientific terms used herein have the same meaning as commonly understood to one of ordinary skill in the art to which the presently disclosed subject matter belongs.

Following long-standing patent law convention, the terms “a,” “an,” and “the” refer to “one or more” when used in this application, including the claims.

The term “and/or” when used in describing two or more items or conditions, refers to situations where all named items or conditions are present or applicable, or to situations wherein only one (or less than all) of the items or conditions is present or applicable.

The use of the term “or” in the claims is used to mean “and/or” unless explicitly indicated to refer to alternatives only or the alternatives are mutually exclusive, although the disclosure supports a definition that refers to only alternatives and “and/or.” As used herein “another” can mean at least a second or more.

The term “comprising,” which is synonymous with “including,” “containing,” or “characterized by” is inclusive or open-ended and does not exclude additional, unrecited elements or method steps. “Comprising” is a term of art used in claim language which means that the named elements are essential, but other elements can be added and still form a construct within the scope of the claim.

As used herein, the phrase “consisting of” excludes any element, step, or ingredient not specified in the claim. When the phrase “consists of” appears in a clause of the body of a claim, rather than immediately following the preamble, it limits only the element set forth in that clause; other elements are not excluded from the claim as a whole.

As used herein, the phrase “consisting essentially of” limits the scope of a claim to the specified materials or steps, plus those that do not materially affect the basic and novel characteristic(s) of the claimed subject matter.

With respect to the terms “comprising,” “consisting of,” and “consisting essentially of,” where one of these three terms is used herein, the presently disclosed and claimed subject matter can include the use of either of the other two terms.

Unless otherwise indicated, all numbers expressing quantities of time, temperature, weight, concentration, volume, strength, speed, length, width, and so forth used in the specification and claims are to be understood as being modified in all instances by the term “about.” Accordingly, unless indicated to the contrary, the numerical parameters set forth in this specification and attached claims are approximations that can vary depending upon the desired properties sought to be obtained by the presently disclosed subject matter.

As used herein, the term “about,” when referring to a value is meant to encompass variations of in one example±20% or ±10%, in another example ±5%, in another example±1%, and in still another example±0.1% from the specified amount, as such variations are appropriate to perform the disclosed methods.

Numerical ranges recited herein by endpoints include all numbers and fractions subsumed within that range (e.g., 1 to 5 includes 1, 1.5, 2, 2.75, 3, 3.90, 4, 4.24, and 5). Similarly, numerical ranges recited herein by endpoints include subranges subsumed within that range (e.g., 1 to 5 includes 1-1.5, 1.5-2, 2-2.75, 2.75-3, 3-3.90, 3.90-4, 4-4.24, 4.24-5, 2-5, 3-5, 1-4, and 2-4).

As used herein, a “monomer” refers to a non-polymeric molecule that can undergo polymerization, thereby contributing constitutional units, i.e., an atom or group of atoms, to the essential structure of a macromolecule.

As used herein, a “macromolecule” refers to a molecule of high relative molecular mass, the structure of which comprises the multiple repetition of units derived from molecules of low relative molecular mass, e.g., monomers and/or oligomers.

An “oligomer” refers to a molecule of intermediate relative molecular mass, the structure of which comprises a small plurality (e.g., 2, 3, 4, 5, 6, 7, 8, 9, or 10) of repetitive units derived from molecules of lower relative molecular mass.

As used herein the terms “polymer,” “polymeric” and “polymeric matrix” refer to a substance comprising macromolecules. In some embodiments, the term “polymer” can include both oligomeric molecules and molecules with larger numbers (e.g., >10, >20, >50, >100) of repetitive units. In some embodiments, “polymer” refers to macromolecules with at least 10 repetitive units. A “copolymer” refers to a polymer derived from more than one species of monomer.

The term “thermoplastic” can refer to a polymer that softens and/or can be molded above a certain temperature, but which is solid below that temperature. Thermoplastic polymers include, but are not limited to, ethylene vinyl acetate copolymers (EVA), polyolefins (e.g., polypropylene (PP), polyamides, some polyesters (e.g., polybutylene terephthalate (PBT)), polystyrenes, styrene block copolymers (SBCs), polyaryletherketones (e.g., polyether ether ketone (PEEK), polyether ketone (PEK)), polycarbonates, polysulfones (e.g., polyether sulfone (PES)), polyarylene sulfides (e.g., polyphenylene sulfide (PPS)), silicone rubbers, fluoropolymers, thermoplastic elastomers, polypyrrole, polycaprolactone, polyoxymethylene (POM), and mixtures and/or combinations thereof.

The terms “thermoset” and “thermosetting” refer to a polymer that is irreversibly solidified when polymer precursors (e.g., monomers and/or oligomers, which can also be referred to as “resins” or “pre-polymers”) react with one another when exposed to heat, suitable radiation (e.g., visible or ultraviolet light), and/or suitable chemical conditions (e.g., the addition of a chemical polymerization initiator or catalyst (e.g. a peroxide) and/or exposure to suitable pH conditions (such as brought about by the addition of an acid or base)). Thermoset polymers include, but are not limited to, epoxys, polyesters, vinyl esters, phenol formaldehyde systems (e.g., Bakelite), polyurethanes, polyurea/polyurethane hybrids, cyanoacrylates, acrylic polymers (e.g., methacrylates), and mixtures and/or combinations thereof.

The term “resin” when used with regard to a thermosetting polymer can refer to a mixture of the polymer precursors that can be further polymerized and/or crosslinked during curing. The term “resin” can also be used herein to refer to monomers, oligomers, polymers and/or mixtures thereof that can be polymerized or further polymerized to form a thermoplastic polymer.

The terms “roving” and “tow” as used herein refer to a bundle of filaments, often containing thousands or tens of thousands of individual filaments. For example, in some embodiments, the tows referred to herein can comprise between about 3,000 and about 50,000 individual filaments. In some embodiments, the tow can include more than 50,000 filaments, more than 75,000 filaments, or more than 100,000 filaments. The terms “fiber bundle,” “fiber roving” and “fiber tow” can be used interchangeably herein. In some embodiments, the carbon fiber described herein can comprise a plurality of tows, wherein each tow has a uniform cross-sectional dimension and/or the same approximate number of filaments.

The term “polymer impregnated” as in “polymer impregnated fiber tow” can refer to a porous or fibrous material, e.g., a fiber tow, permeated or saturated with polymer resin, cured polymer, or a mixture thereof. Thus, a polymer impregnated material can comprise cured and/or uncured polymer inside the pores and/or between the fibers of the material.

### II. General Considerations

With the advent of heavier electric and hybrid cars and stringent Corporate Average Fuel Economy (CAFÉ) standards, light weighting automotive components is an increasingly helpful approach to meet the requirements of fuel efficiency. For example, one solution being considered is using polymer composites in body panels and other structural components to lower the overall weight of the vehicle. Carbon fiber (CF) composites have proven themselves the material of choice in aerospace industry for decades because of their superior tailorable, but their high cost has been a detriment in their adoption in the automotive industry. There has been significant development in reducing the cost of CF by changing the precursor used to make the CF and some energy saving innovations while processing it. One of these developments is led by the Carbon Fiber Technology Facility (CFTF) at Oak Ridge National Laboratory (ORNL). CFTF has a pilot plant that manufactures this low-cost CF with a goal to reduce cost to 5$ per pound (over current cost of commercial CF which ranges from $8 to $20 per pound). However, textile grade CF (TCF) is very difficult to handle and process because of its large tow size of 350 to 450 K individual filaments, non-circular fiber profile, and brittle nature. Overcoming the fiber handling issues would greatly help in its adoption into the industry.

Conventionally, polymer composites use thermosets like epoxy or polyesters as matrices due to their low cost, good fatigue strength, low viscosity at ambient temperatures, and ability to wet out the fiber. But thermosets have some disadvantages, like low impact properties, limited shelf life, large processing time due to need for curing, and difficulty in recycling. In contrast, thermoplastics provide excellent impact properties, unlimited shelf life, recyclability, and quick processing times. However, they have their own share of disadvantages like high viscosity and the high energy required to process the polymer. The technical challenges include overcoming these problems to get good wet out of the fiber. Impregnating TCF with thermoplastic polymers provides cost-effectives intermediates for various manufacturing processes, and thereby components for the automotive industry.

The presently disclosed subject matter is based, in one aspect, on the production of a fully impregnated TCF tape with a target 30 to 70% fiber weight fraction. This tape is an intermediate and can be used as raw material in downstream processes, such as extrusion compression molding, injection molding, continuous 3D printing or tape layup.

An exemplary process of the presently disclosed subject matter starts with unwinding of dry TCF from pneumatically pre-tensioned creel holder. The width of the dry fiber depends on the tow size. For instance, an exemplary 350 K tow (comprising 350,000 individual filaments) is approximately 2.7 inches wide. This dry fiber tow is uniformly spread (e.g., to a width of 4 inches) using a bowed spreader roller. The bowed roller has an adjustable radius of curvature that can be tuned according to the degree of spread desired. The spread fiber can then be preheated by forcing the fiber to go across heated bars to match the temperature of the molten polymer resin. This can be done so that the polymer does not lose heat and retains low viscosity as it meets the fiber. The molten polymer resin can flow and envelope the individual filaments to get good wet out. The heated fiber enters an impregnation die (first impregnation stage) and travels across the curvature of a die, e.g., a sheet or film extrusion die (e.g., a coat-hanger die or T slot die), extruding a uniform sheet of molten polymer resin. The die can be connected to a single screw extruder that melts polymer resin by a combination of thermal forces and the shearing action of the screw against the barrel. The quality of the polymer resin melt and throughput can be controlled by manipulating the rotational speed and temperature of the extruder. From the extruder, the molten polymer resin can enter the die (e.g., the coat hanger or other sheet or film extrusion die) and is uniformly spread to a sheet, e.g., that is about 4 inches wide and 1/16 inch thick. As the fiber traverses across the slit of the impregnation die (e.g., the coat hanger or other sheet or film extrusion die), it is wetted by the molten polymer resin. In some embodiments, the tow next enters a pin massaging die (second impregnation stage) where it is forced to go through pairs of pins set at different break angles. The break angles improve wet out by both physically forcing the polymer into the tow and shear thinning of polymer at points of high tension. The fully impregnated tape can be immediately cooled using chilled air knifes extending from a dual vortex tube. The cooled tape can then be pulled by a pinch roller system that sets the speed of the line. This tape can then be rewound onto cardboard tubes using a tension-controlled re-winding system.

The presently disclosed process and system can provide a uniformly impregnated wide tow TCF. The first and optional second stages of impregnation will now be described in further detail.

### II.A. First Impregnation Stage

The interaction between the fiber and the polymer in this stage was optimized using Darcy's law. Darcy's law is an equation that describes the flow of fluid through a porous medium as given below.

$$Darcy ' s Law : \qquad q = - ( k / μ ) ∇ p ,$$

where q is the velocity through a medium, k is the permeability of the medium (fiber), μ is the viscosity of fluid (polymer) and ∇p is the pressure gradient over distance.

From the equation it is observed that the impregnation of the fiber can be optimized by max k, max ∇p and min μ. Each parameter was individually considered, and an exemplary die was designed around these parameters.

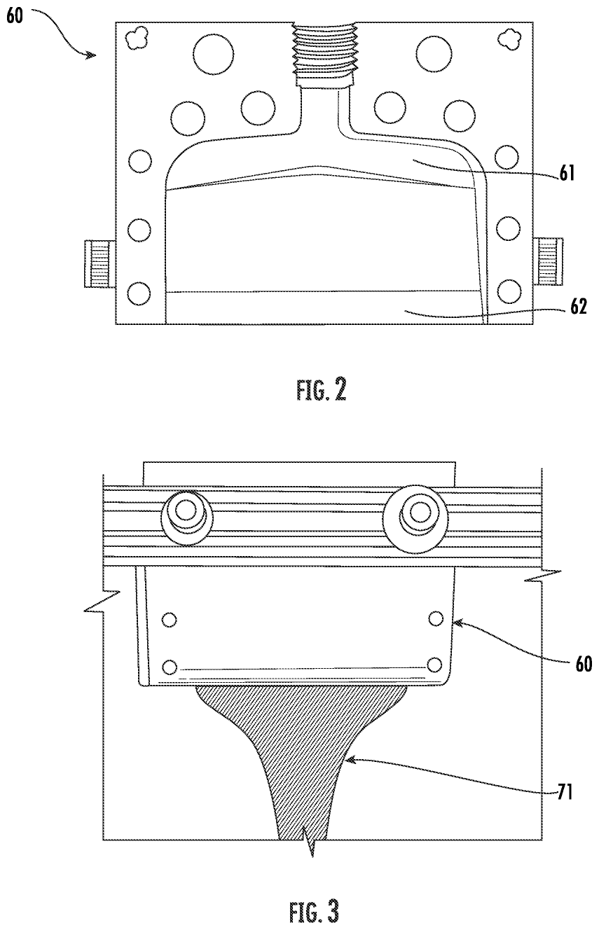

A first parameter considered was u or viscosity of polymer. Thermoplastics exhibit non-Newtonian pseudoplastic behavior, where on application of shear forces the polymer thins or becomes less viscous. A coat-hanger impregnation dies, or other sheet or film extrusion die, for example, can shear thin the polymer at its exit lips by constricting the passage of flow and by inducing shear stress. See FIGS. 2 and 3.

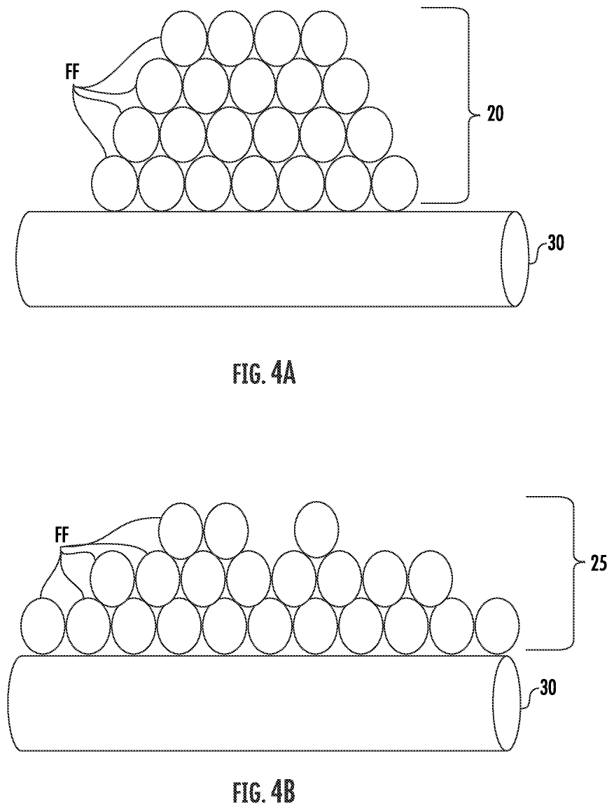

Another parameter addressed was k or permeability of medium. Carbon fiber tow is a collection of several individual filaments packed together with individual filaments overlapping one over another. These filaments are closely packed and hence create a torturous path for the molten polymer resin to infiltrate. See FIG. 4A. According to an example of the presently disclosed subject matter described hereinbelow, a fiber tow was uniformly spread from its original 2.7 inches width to 4 inches width, which causes the individual filaments to spread out (see FIG. 4B) creating a more permeable path for the polymer resin to impregnate. It has been observed experimentally that more spreading of the tow can result in better impregnation of the polymer.

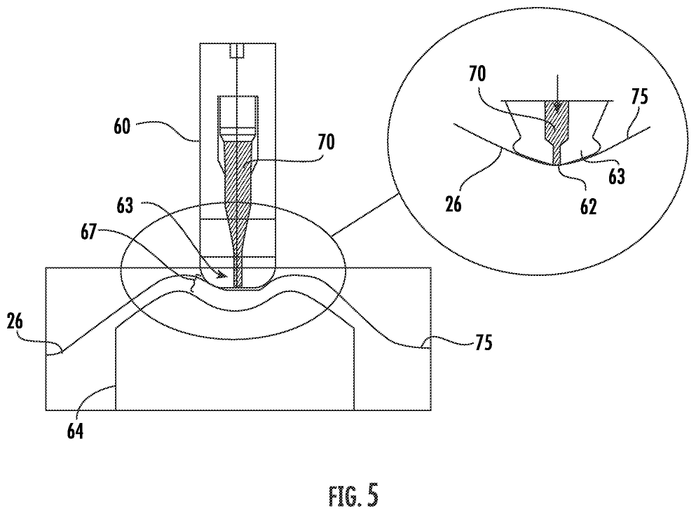

Yet another parameter investigated was ∇p or pressure gradient over the thickness of the tow. Computational fluid dynamics (CFD) was undertaken on the coat hanger geometry to ensure smooth melt flow without any stagnating or recirculating flow regions. The molten polymer resin is at a high pressure inside the die, but it loses that property as soon as it exits the die. The CFD simulation validated the geometry to confirm there is minimum pressure drop as the molten polymer resin exits the lips/exit slit of the die. High pressure polymer resin is desirable as it can penetrate through the fiber tow. To achieve this, the die was given a generous curvature of around 40 mm at its die head/extrusion slit and the fiber was forced to conform to the curvature of the extrusion slit allowing intimate contact between fiber and the curvature of the extrusion slit. See FIG. 5. This means the fibers capture the molten polymer resin in its most desirable condition.

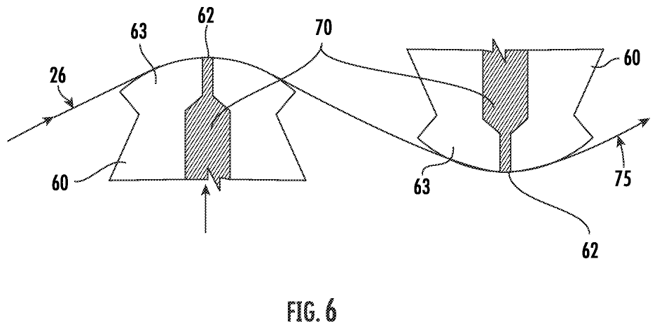

In some embodiments, the first impregnation stage can include more than one die head. See FIG. 6, which shows an impregnation die including two exit slits on two separate curved die heads. In some embodiments, such as shown in FIG. 6, the two exit slits and their corresponding curved die heads are positioned such that, as the carbon fiber tow is pulled through the impregnation die, it can be contacted with a sheet of molten polymer resin on both the top and bottom surfaces.

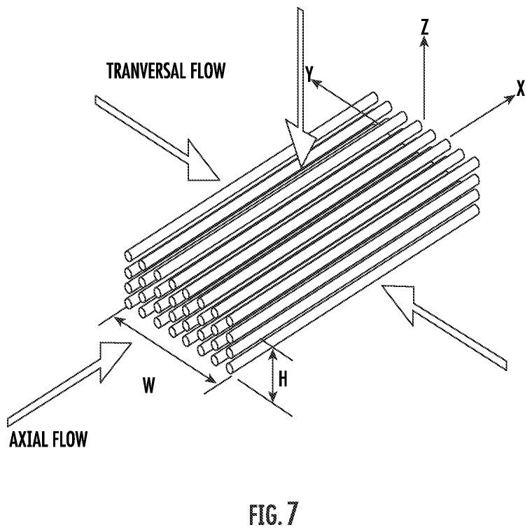

The permeability coefficient of the tow in the transverse direction (see FIG. 7) is higher than in axial direction; hence by design the molten polymer resin enters the tow from the perpendicular direction. As the molten polymer resin enters the tow it gradually displaces the air entrapped within. This die design has space under the point of impregnation to allow for air egress.

### II.B. Second Impregnation Stage

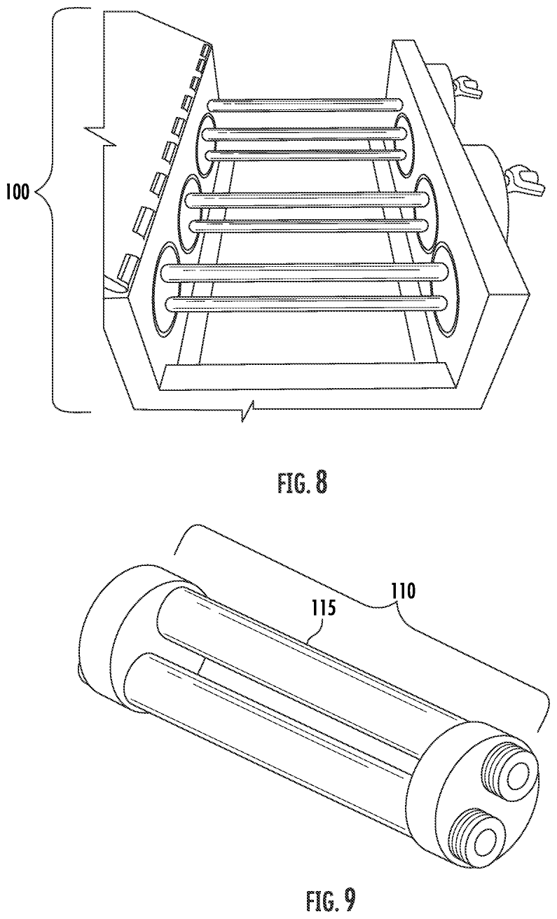

The second impregnation stage can comprise the pin die (i.e., a massaging die), which, in some embodiments, comprises or consists of 4 pairs of heated bars where each set of pins can be indexed in increments of 15° angles. See FIGS. 8, 9, and 10. Various combinations of the pins were experimentally tested with different configurations to find the optimum setting that resulted in good wet out. The pin die can be adjusted even when heated, which allows the end user to change the angles while processing.

### II.C. Processing Conditions

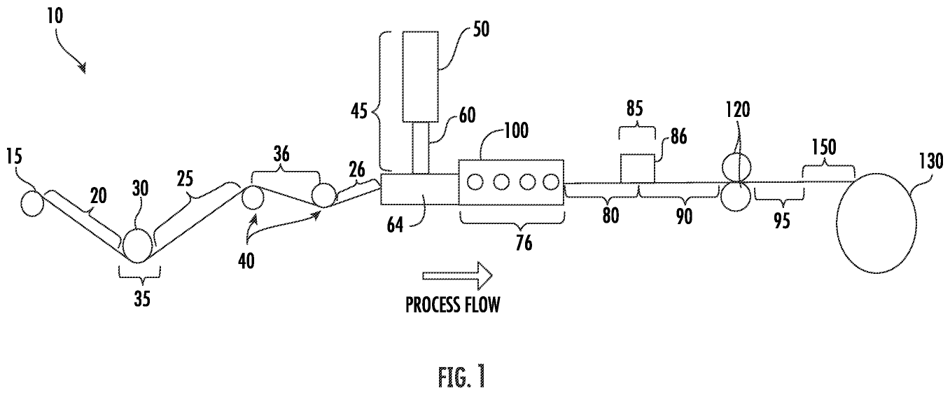

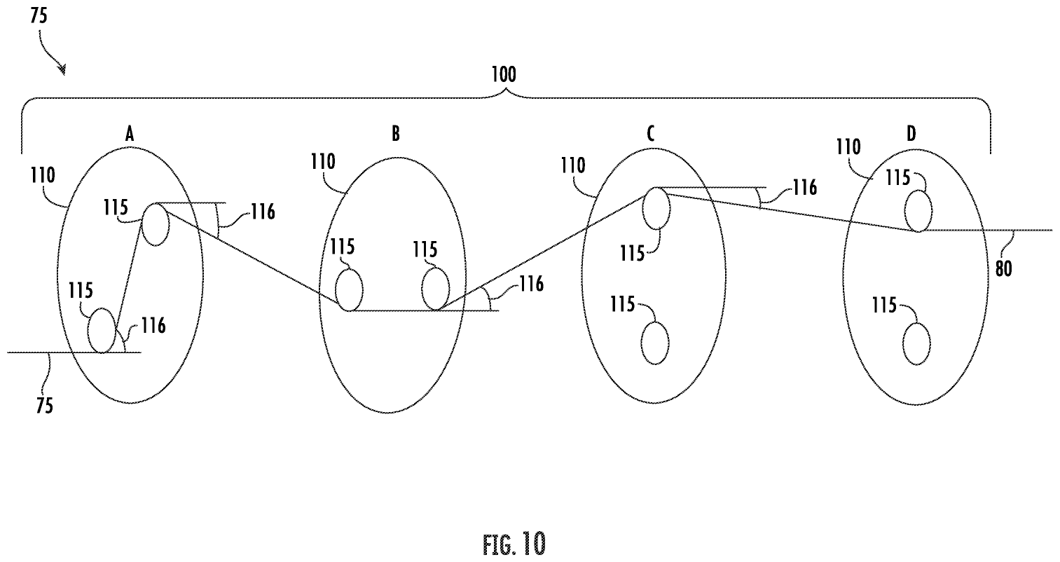

Table 1, below, lists the temperature in different areas of the system shown in FIG. 1 and described above that were used in the examples described below. In the examples, a haul off rate of 1 ft/min was used. Table 2 below describes exemplary break angles used in the pin die illustrated in FIG. 10.

TABLE 1
Exemplary Processing Conditions.
Temperature in different areas of the impregnation line

| | |
|---|---|
| Preheater | 260° C. |
| Extruder Zone 1 | 240° C. |
| Extruder Zone 2 | 250° C. |
| coat-hanger die | 250° C. |
| coat-hanger base die | 250° C. |
| Pin die | 240° C. |

TABLE 2
Position of pins in the pin die and the break angles.

| | | | Fiber break | Fiber break |
|---|---|---|---|---|
| | | | angle on | angle on |
| Sr. No. | Position | Pin | first pin | second pin |
| A | 45 | 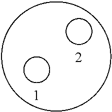 | 60 | 25 |
| B | 0 | 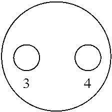 | 0 | 30 |
| C | 90 | 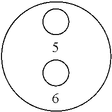 | 10 | — |
| D | 90 | 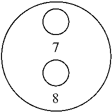 | 0 | — |

### III. Process

In some embodiments, the presently disclosed subject matter provides a process for preparing a CFRP intermediate product or CFRP intermediate tape product, wherein the CFRP intermediate product comprises carbon fiber and a polymeric matrix. In some embodiments, the process employs a system and comprises spreading a carbon fiber tow to provide a spread carbon fiber tow. In some embodiments, the process comprises heating the spread carbon fiber tow to provide a heated spread carbon fiber tow. In some embodiments, the process comprises extruding molten polymer resin from first impregnation die (e.g., extruding a sheet of a molten polymer resin as shown in FIG. 3 as discussed herein below) and impregnating a carbon fiber tow (e.g., spread carbon fiber tow 25 as shown in FIG. 1) with molten polymer resin. In some embodiments, the process further comprises heating a carbon fiber tow (e.g., a spread carbon fiber tow) and/or cooling a polymer impregnated carbon fiber tow. In some embodiments, the process comprises: (a) spreading a carbon fiber tow to provide a spread carbon fiber tow; (b) heating a spread carbon fiber tow to provide a heated spread carbon fiber tow; (c) extruding a molten polymer resin through a first impregnation die, wherein the molten polymer resin is a molten thermoplastic or melt-processable thermosetting polymer resin corresponding to the polymeric matrix of the CFRP intermediate product, and wherein, as shown in FIGS. 2 and 3 discussed herein below, the first impregnation die comprises a chamber and an extrusion slit, wherein the first impregnation die is configured to extrude a sheet of molten polymer resin (see FIG. 5 discussed herein below) from the extrusion slit; (d) impregnating the heated spread carbon fiber tow with molten polymer resin, wherein the impregnating comprises contacting the heated spread carbon fiber tow with the sheet of molten polymer resin, thereby providing a polymer impregnated carbon fiber tow; and (e) cooling the polymer impregnated carbon fiber tow to provide a cooled, polymer impregnated carbon fiber.

In some embodiments, the carbon fiber tow comprises more than about 50,000 individual filaments. In some embodiments, the carbon fiber tow comprises more than about 60,000 filaments, more than about 70,000 filaments, more than about 75,000 filaments, more than about 80,000 filaments, more than about 90,000 filaments, or more than about 100,000 filaments. In some embodiments, the carbon fiber tow comprises at least about 150,000 filaments, about 200,000 filaments, about 250,000 filaments or about 300,000 filaments or more. In some embodiments, the carbon fiber tow comprises about 300,000 filaments to about 600,000 filaments. The number of filaments in the carbon fiber precursor fiber tows corresponds to the number of filaments in the carbon fiber intermediate produced therefrom.

In some embodiments, prior to step (a), the carbon fiber tow is heated and/or tensioned. In some embodiments, the carbon fiber tow is treated to eliminate a sizing agent or agents prior to step (a) or otherwise providing an unsized carbon fiber tow.

Referring to FIGS. 4A and 4B, in some embodiments, the spreading is performed by passing the carbon fiber tow 20 under tension over and/or under a spread roller 30 thereby spreading carbon fiber filaments (e.g., uniformly spreading carbon fiber filaments FF) in carbon fiber tow and providing spread carbon fiber tow. For example, a 2.7-inch-wide carbon fiber tow can be spread to about 4 inches. In some embodiments, the spreading comprises spreading the carbon fiber filaments FF in carbon fiber tow to about the maximum uniform spread possible without any gaps forming between carbon fiber filaments.

In some embodiments, heating the spread carbon fiber tow comprises heating the spread carbon fiber tow to about a melt temperature (e.g., to within about 20° C., 10° C., 5° C., 2° C., or about 1° C. of a melt temperature) of the molten polymer resin corresponding to the polymeric matrix of the CFRP intermediate product. For example, as shown in with FIG. 1 as discussed herein below, in some embodiments, the heating comprises passing the spread carbon fiber tow over one or more heated bars and/or through an oven.

The polymeric resin used to impregnate the carbon fiber tow can be any suitable polymeric resin can be used to provide a CRFP intermediate product with a desired property. Accordingly, virtually any thermoplastic resin or thermosetting resin suitable for forming into articles by thermal processes, molding, extrusion, or other such processes can be used. For example, and without limitation, the following thermoplastic materials can be used: acrylonitrile-butadiene-styrene (ABS) resins; acetal resins; acrylics; acrylonitriles (AN); allyl resins; cellulosics; epoxies; polyarylether ketones, e.g., polyether etherketone (PEEK) and polyether ketone (PEK); liquid crystal polymers, such as those sold under the tradename Xydar by Amoco Polymers Inc., Atlanta, Georgia, United States of America; amino resins, including melamine, melamine formaldehyde resins, urea formaldehyde resins, guanidines, and so on; phenolics; polyamides, such as nylon 6 (polycaprolactam), nylon 66, poly(tetra-methylene) adipamide and polyphthalamide; polyimides; polyamide-imide resins; polyolefins, such as polyethylene, polypropylene (PP), and polybutylene homopolymers and copolymers; polycarbonates; polyesters, such as polyalkylene terephthalates including, without limitation, polybutylene terephthalate (PBT) and polyethylene terephthalate (PET); polyimides and polyetherimides; polyphenylene oxide; polyarylene sulfites such as polyphenylene sulfite; polyarylene sulfides such as polyphenylene sulfide (PPS); polyvinyl resins, including, without limitation, polystyrene (PS) and copolymers of styrene such as styrene-acrylonitrile copolymer (SAN), polyvinyl chloride (PVC), and polyvinylphenylene chloride; polyurethanes; and polysulfones, including, without limitation, polyaryl-ether sulfones, polyether sulfones (e.g., PES), and polyphenyl sulfones. In some embodiments, the polymeric resin comprises a thermoplastic polymer selected from the group comprising a polyolefin, a polyamide, a polyimide, and a polyurethane. In some embodiments, the polymeric resin comprises a thermosetting polymer selected from the group comprising an epoxy (e.g., an epoxy that cures with amines, acids or acid anhydrides), a polyimide, and a polyester (e.g., a polyester that cures through unsaturation). Additional exemplary thermosetting resins include bismaleimides and phenolics. In some embodiments, the polymeric resin comprises a mixture of two or more resins.

In some embodiments, the resin can include one or more additives, such as, but not limited to, impact modifiers, mold release agents, lubricants, thixotropes, antioxidants, UV absorbers, heat stabilizers, flame retardants, pigments, colorants, nonfibrous reinforcements and fillers, plasticizers, impact modifiers such as ionomers or maleated elastomers, and other ingredients and additives known in the field. In the case of a thermoset resin, a catalyst or initiator for the curing reaction can be included.

The melt flow rate (MFR) of the polymeric resin is not particularly limited. The MFR (or melt flow index (MFI)) of a polymeric resin is a measure of the ease of flow of a melted plastic. MFI can be determined, for example, as described in ASTM D1238 and ISO 1133. Briefly, a small sample of about 5 grams is heated above its melting or softening point and forced through a capillary using a piston actuated by a specified weight, e.g., about 2.16 kilograms (kg) or about 5 kg. The weight of melt in grams flowing through the capillary in 10 minutes is the MFI or MFR. In some embodiments, the polymeric resin used according to the presently disclosed subject matter has an MFR of between about 5 and between about 100.

In some embodiments, a flow enhancer (i.e., a low molecular weight polymer of the same composition as the polymeric resin) can be added to the polymeric resin to increase the MFR. In some embodiments, the polymeric resin is mixed with a flow enhancer to provide a mixture of about 20%, about 30% or about 40% flow enhancer. The addition of the flow enhancer can provide a smoother surface finish for the impregnated carbon fiber and/or increase the ability to flood the impregnation die with polymer resin. Suitable flow enhancers include, but are not limited to, ProFlow and other resins from Polyvisions Inc. (Manchester, Pennsylvania, United States of America). In some embodiments, the flow enhancer can have an MFR of more than 100. In some embodiments, extruder size can be adjusted based on the MFR. For instance, when a lower MFR resin is used, a larger extruder can be employed.

In some embodiments, the first impregnation die comprises at least one sheet or film extrusion die, such as shown in FIGS. 2, 3, and 5 discussed herein below. In some embodiments, the sheet or film extrusion die is a coat hanger die. See FIG. 2. In some embodiments, the sheet or film extrusion die is a T slot die. In some embodiments, the sheet or film extrusion die has a curved die head, such as shown in FIG. 5. In some embodiments, the heated spread carbon fiber tow is conformed to said curved head during the impregnating. In some embodiments, such as shown in FIG. 5 discussed herein below, the first impregnation die includes a solid body or die base configured to create a slot for pulling the heated spread carbon fiber tow along a path conformed to the curved die head and past extrusion slot. In some embodiments, the first impregnation die extrudes a sheet of molten polymer resin (e.g., a uniform sheet of molten polymer resin) that has about the same width as the heated spread carbon fiber tow. In some embodiments, the first impregnation die includes more than one sheet or film extrusion die. In some embodiments, such as shown in FIG. 6 discussed herein below, the first impregnation die includes two sheet or film extrusion dies configured to extrude sheets of molten polymer resin from extrusion slots) on opposite sides of the heated spread carbon fiber tow.

In some embodiments, wet out of the carbon fiber with the polymeric resin can be increased by pulling the carbon fiber though one or more rollers, one or more rotatable rounded bars (also referred to herein as “impregnation bars”), or an exit die (comprising one or more rollers, bars and/or pins). Thus, as shown for example in FIGS. 8-10 discussed herein below, in some embodiments, contacting the heated spread carbon fiber tow with the sheet (or sheets) of molten polymer resin provides a semi-impregnated carbon fiber tow and the impregnating step further comprises mechanically contacting the semi-impregnated carbon fiber tow to provide the impregnated carbon fiber tow. In some embodiments, mechanically contacting the semi-impregnated carbon fiber tow comprises passing the semi-impregnated carbon fiber tow through a series of pins or impregnation bars or through an exit die in a second impregnation stage. In some embodiments, the series of pins or impregnation bars are configured in a second impregnation die. In some embodiments, the second impregnation die is heated to a melt temperature of the molten polymer resin.

As shown in FIGS. 8-10 discussed herein below, in some embodiments, the series of pins (i.e., A, B, C, and D) or impregnation bars comprise a series of pin pairs. In some embodiments, the series of pin pairs are configured to provide one or more different break angles, such as described hereinabove in Table 2. In some embodiments, the rollers, impregnation bars, or exit die is heated, e.g., to keep the resin melted while it is pushed further though a carbon fiber tow to wet out additional individual filaments therein).

In some embodiments, the impregnated carbon fiber comprises between about 30 weight % (wt %) and about 70 wt % carbon fiber. In some embodiments, the impregnated carbon fiber comprises between about 30 wt % and about 70 wt % or about 30 wt % to about 50 wt % carbon fiber (e.g., about 30, 31, 32, 33, 34, 35, 36, 37, 38, 39, 40, 41, 42, 43, 44, 45, 46, 47, 48, 49, or about 50 wt % carbon fiber). In some embodiments, the impregnated carbon fiber comprises between about 35 wt % carbon fiber and about 45 wt % carbon fiber.

During cooling step (e), the polymeric resin in the impregnated carbon fiber (80) cools and solidifies. In addition, the impregnated carbon fiber can be shaped, if desired, during cooling to provide a desired cross-sectional shape. For example, if a continuous tape or ribbon is the desired intermediate product (as shown in FIG. 11), or if relatively flat chips or flakes are desired, the ribbon- or tape-like geometry of the impregnated carbon fiber after it leaves step (d) can be maintained and/or further smoothed by pulling the impregnated carbon fiber though one or more rollers. The one or more rollers can include a series of at least two free turning cylinders through while the impregnated carbon fiber can be pulled. Alternatively, if a rod-shaped geometry is desired for the CFRP intermediate product (either as a continuous rod-shaped product or as discontinuous rod-shaped pellets), the cooling process can comprise shaping the impregnated carbon fiber to have a circular or other cross-sectional shape (e.g., an oval, square, rectangle, triangle, or any other regular or irregular cross-sectional shape). The shaping can be performed by applying pressure (e.g., mechanically or manually) to the sides of a tow of impregnated carbon fiber, decreasing the width of the tow. This can be referred to as “bunching.” In some embodiments, the shaping can be performed by pulling the impregnated carbon fiber through a die having an outlet and/or interior channel with a desired cross-sectional shape (i.e., a circle or other shape).

In some embodiments, the cooling can comprise or further comprise cooling the impregnated carbon fiber by contacting it with cooled air or cooled water. In some embodiments, the cooling can comprises impinging a surface of the impregnated carbon fiber with one or more streams of cooled air or water (e.g., from one or more jets or hoses). In some embodiments, the cooled air or water stream or streams can be directed at a top surface of the impregnated carbon fiber. In some embodiments, the impregnated carbon fiber is pulled through a chamber filled with cooled air (e.g., from an air hose connected to the chamber) or a cooled water bath.

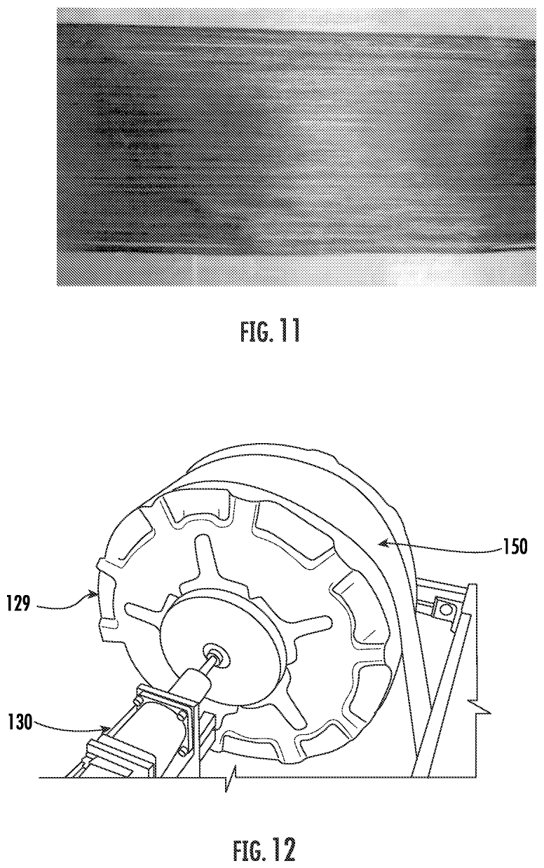

In some embodiments, the carbon fiber precursor, carbon fiber, and/or impregnated carbon fiber is pulled through a pulley, a puller device, or a tensioning roll to maintain a desired line speed and/or tension, e.g., after step (e). In some embodiments, step (f) comprises further processing the cooled, polymer impregnated carbon fiber. In some embodiments, step (f) comprises feeding the cooled, polymer impregnated carbon fiber onto a spool (e.g., as shown in FIG. 12) or a tape winder (e.g., as shown in FIG. 1) or comprises pelletizing or chopping cooled, polymer impregnated carbon fiber. As shown in FIG. 1, in some embodiments, the cooled, polymer impregnated carbon fiber is pulled through a puller device prior to step (f) (and after step (e)) to maintain a desired speed and/or tension and/or to feed the cooled, impregnated carbon fiber into a chopper or a pelletizer or onto a tape winder.

In some embodiments, step (f) comprises winding the cooled, impregnated carbon fiber onto a roller, tape winder or spool to provide a roll of a continuous tape, ribbon, or rod-shaped CFRP intermediate. In some embodiments, step (f) comprises chopping or pelletizing the cooled, impregnated carbon fiber to provide chips, flakes, or pellets of the CFRP intermediate product.

Exemplary temperatures for the steps disclosed herein are described hereinabove in Table 1. Exemplary break angles for the second impregnation stage are described hereinabove in Table 2.

In some embodiments, the presently disclosed subject matter provides CFRP intermediate product prepared according to the process of the presently disclosed subject matter. In some embodiments, the CFRP is a tape or ribbon. In some embodiments, the CFRP comprises TCF. In some embodiments, the CFRP comprises a fully impregnated TCF. The term “fully impregnated” as used herein refers to a tape comprising carbon fibers incapsulated in a polymeric matrix comprising less than about 5% void volume (e.g., resulting from air pockets within the tape) and/or at least about 95% of the carbon fiber surface area being in physical contact with polymeric matrix.

### IV. Systems

Referring to FIGS. 1-12, in some embodiments, the presently disclosed subject matter provides a system for preparing a CFRP intermediate product 150 or CFRP intermediate tape product, wherein the CFRP intermediate product 150 comprises carbon fiber and a polymeric matrix. In some embodiments, the polymeric matrix comprises a thermoplastic polymeric matrix or a thermoset polymeric matrix of a melt-processable thermosetting polymer resin.

Referring now to FIGS. 1, 2 and 3, in some embodiments, the system 10 comprises an impregnation stage 45 comprising a first impregnation die 60 comprising an extrusion slit 62 for extruding a sheet 71 of molten polymer resin 70. In some embodiments, the impregnation stage 45 comprises an extruder 50 or a polymer resin feed tube configured to supply molten polymer resin 70 to chamber 61 associated with the impregnation die 60. In some embodiments, the system 10 comprises a fiber spreading stage 35 configured to spread carbon fiber tow 20. In some embodiments, the system 10 comprises carbon fiber tow feed roll 15. In some embodiments, the system 10 comprises a pre-heating stage 36 configured to heat carbon fiber tow 20 (e.g., a spread carbon fiber tow 25). In some embodiments, the pre-heating stage 36 is configured to heat carbon fiber tow 20 or spread carbon fiber tow 25 to a temperature at or near that of molten polymer resin 70. In some embodiments, the system 10 further comprises a cooling stage 85 to cool polymer impregnated carbon fiber 80.

Continuing with reference to FIGS. 1, 2, and 3, in some embodiments, the system 10 comprises a carbon fiber tow feed roll 15; the fiber spreading stage 35 configured to receive carbon fiber tow 20 from carbon fiber tow feed roll 15 and spread the carbon fiber tow 20; the pre-heating stage 36 configured to receive spread carbon fiber tow 25 from the fiber spreading stage 35 and to heat spread carbon fiber tow 25; a first impregnation stage 45 configured to receive the heated carbon fiber tow 26 from the pre-heating stage 36 and comprising (1) first impregnation die 60 and (2) extruder 50 or a polymer resin feed tube, wherein said first impregnation die 60 comprises chamber 61, extrusion slit 62, and a die base 64, wherein said extruder 50 or polymer resin feed tube is configured to supply molten polymer resin 70 corresponding to the polymeric matrix of the CFRP intermediate product 150 to chamber 61 of first impregnation die 60 and wherein extrusion slit 62 is configured to extrude sheet 71 of molten polymer resin 70 onto a surface of heated carbon fiber tow 26 received from pre-heating stage 36; and cooling stage 85, positioned to receive polymer impregnated carbon fiber 80 from the first impregnation stage 45, wherein polymer impregnated carbon fiber 80 is cooled.

Continuing with reference to FIGS. 1, 2, and 3, in some embodiments, the system 10 comprises a second impregnation stage 76 configured to mechanically contact a carbon fiber tow (e.g., partially impregnated carbon fiber tow 80). In some embodiments, first impregnation stage 45 is configured to mechanically contact a carbon fiber tow with a first impregnation stage 45 of the system wherein system 10 further comprising a first impregnation stage 45 configured to partially impregnate carbon fiber tow 20 (e.g., a spread carbon fiber tow 25) with molten polymer resin 70 (e.g., sheet 71 of molten polymer resin 70). In some embodiments, the system 10 comprises fiber spreading stage 35, a first impregnation stage 45 comprising a first impregnation die 60 comprising an extruder 50 or molten polymer resin feed tube, and a second impregnation stage 76 configured to mechanically contact a carbon fiber tow 20 (e.g., a spread carbon fiber tow 25). In some embodiments, the system 10 further comprises one or more of a carbon fiber tow feed roll 15, pre-heating stage 36 to heat carbon fiber tow 20 to about the melt temperature of a polymer resin; cooling stage 85 configured to cool an impregnated carbon fiber tow 80, and a processing stage 95, e.g., to process an impregnated carbon fiber tow 80 into a desired form of a CFRP intermediate product 150, In some embodiments, the system 10 comprises: (i) a carbon fiber tow feed roll 15; (ii) fiber spreading stage 35 configured to receive carbon fiber tow 20 from the carbon fiber tow feed roll 15 and spread said carbon fiber tow; (iii) a pre-heating stage 36 configured to receive spread carbon fiber tow 25 from the fiber spreading stage 35 and to heat spread carbon fiber tow 25 to a temperature to match a melt temperature of a polymer resin corresponding to the polymeric matrix of the CFRP intermediate product 150; (iv) a first impregnation stage 45 configured to receive heated carbon fiber tow 26 from the pre-heating stage 36, said first impregnation stage 45 comprising (1) a first impregnation die 60 and (2) an extruder 50 or a polymer resin feed tube, wherein said first impregnation die 60 comprises a chamber 61 and an extrusion slit 62, wherein said extruder 50 or polymer resin feed tube is configured to supply molten polymer resin 70 corresponding to the polymeric matrix of the CFRP intermediate product 150 to the chamber 61 of the first impregnation die 60 and wherein the extrusion slit 62 is configured to extrude a sheet 71 of molten polymer resin 70 onto a surface of the heated carbon fiber tow 26 received from pre-heating stage 36; (v) a second impregnation stage 76 configured to receive carbon fiber tow from the first impregnation stage 45, said second impregnation stage 76 configured such that carbon fiber tow received from the first impregnation stage 45 is mechanically contacted as it passes through the second impregnation stage 76; (vi) a cooling stage 85, positioned to receive polymer impregnated carbon fiber 80 from the second impregnation stage 76, wherein the polymer impregnated carbon fiber 80 is cooled; and (vii) a product processing stage 95 positioned to receive a cooled, polymer impregnated carbon fiber 90 after it exits the cooling stage 85 and wherein the cooled, polymer impregnated carbon fiber 90 is processed into a desired form of the CFRP intermediate product 150.

Referring now to FIGS. 1, 2, 3, 4A, and 4B, in some embodiments, the fiber spreading stage comprises a spreader roller 30 configured to spread carbon fiber tow 20 to a desired width. In some embodiments, the spreader roller 30 is a bowed spreader roller. In some embodiments, the spreader roller 30 is a curved bar. Thus, the spreading is performed by passing the carbon fiber tow 20 under tension over and/or under a spread roller 30 thereby spreading carbon fiber filaments (e.g., uniformly spreading carbon fiber filaments FF) in carbon fiber tow and providing spread carbon fiber tow. For example, a 2.7-inch-wide carbon fiber tow can be spread to about 4 inches. In some embodiments, the spreading comprises spreading the carbon fiber filaments FF in carbon fiber tow to about the maximum uniform spread possible without any gaps forming between carbon fiber filaments. In some embodiments, one or more tensioning roll can be configured between the carbon fiber tow feed roll 15 and the fiber spreading stage 35, e.g., to maintain tension in the carbon fiber tow 20. In some embodiments, the system 10 further comprises one or more heated bars 40 configured between the carbon fiber tow feed roll 15 and the fiber spreading stage 35, e.g., to begin heating spread carbon fiber tow 26 to a temperature at or near the temperature of the molten polymer resin 70. In some embodiments, the system 10 further comprises one or more heated bars 40 configured after the carbon fiber tow feed roll 15 and the fiber spreading stage 35, e.g., to begin heating spread carbon fiber tow 26 to a temperature at or near the temperature of the molten polymer resin 70.

Referring to FIGS. 1, 2, 3, 5, and 7, in some embodiments, the first impregnation die 60 comprises a sheet or film extrusion die. In some embodiments, the sheet or film extrusion die is a coat hanger die. In some embodiments, the sheet or film extrusion die is a T slot die. In some embodiments, the extrusion slit 62 is positioned in an end of the first impregnation die 60 having a curved outer surface 63 and the first impregnation stage 45 is configured so that carbon fiber tow passing through the first impregnation stage 45 conforms to the curved outer surface 63. In some embodiments, the first impregnation stage 45 comprises a solid body or die base 64 with a slot 67 configured so that carbon fiber tow pulled through the slot 67 is configured to conform over the curved outer surface 63. In some embodiments, as shown in FIG. 6, the first impregnation stage 45 includes a plurality of impregnation dies (e.g., a plurality of sheet or film extrusion dies). In some embodiments, such as shown in FIG. 6, first impregnation die 60 includes two sheet or film extrusion dies configured to extrude sheets 71 of molten polymer resin 70 from extrusion slots 62 on opposite sides of the heated spread carbon fiber tow 26.

Referring to FIGS. 1, 2, 3, 4, 5, and 7-10, in some embodiments, wet out of the carbon fiber with the polymeric resin can be increased by pulling the carbon fiber though one or more rollers, one or more rotatable rounded bars (also referred to herein as “impregnation bars”), or an exit die (comprising one or more rollers, bars and/or pins). Thus, as shown for example in FIG. 6, in some embodiments, contacting heated spread carbon fiber tow 26 with sheet 71 (or sheets) of molten polymer resin 70 provides a semi-impregnated carbon fiber tow 75 and the impregnating step further comprises mechanically contacting the semi-impregnated carbon fiber tow 75 to provide impregnated carbon fiber tow 80. In some embodiments, mechanically contacting the semi-impregnated carbon fiber tow 75 comprises passing the semi-impregnated carbon fiber tow 75 through series of pins 100 or impregnation bars or through an exit die in a second impregnation stage 76.

In some embodiments, e.g., as shown in FIGS. 8-10, the second impregnation stage 76 comprises a series of pins 100, A, B, C, and D, configured such that the carbon fiber tow 75 passes over or under a plurality of pins in the series of pins 100. In some embodiments, the series of pins 100 are heated or enclosed in a heated body. In some embodiments, the series of pins 100 comprise a series of pin pairs 110 configures so that carbon fiber tow 75 received from the first impregnation stage 45 passes over or under at least one pin 115 of each of the series of pin pairs 110. In some embodiments, the path comprises a least two different break angles 116.

Referring again to FIG. 1, the cooling stage 85 can comprise one or more cooling components 86 to cool and/or shape the polymer impregnated carbon fiber 80. In some embodiments, the cooling stage 85 comprises a cooling component 86 that is a shaping die for forming a rod-shaped material from polymer impregnated carbon fiber 80. The shaping die can be selected to have an exit or channel with a desired cross-sectional shape (e.g., a circle of a desired circumference, an oval, a triangle, a square, a rectangle, an irregular shape or any other desired shape). In some embodiments, the cooling stage 85 comprises a cooling component 86 that can comprise a two opposing surfaces (e.g., a caliper-type device) which can be used to bunch the sides of the impregnated carbon fiber. In some embodiments, the cooling stage 85 comprises cooling component 86 that comprises a series of at least two free-turning rollers through which polymer impregnated carbon fiber 80 can be pulled (e.g., to maintain the polymer impregnated carbon fiber 80 in a flat or ribbon shape and/or to enhance the surface smoothness of the polymer impregnated carbon fiber 80). In some embodiments, the cooling stage 85 comprises cooling component 86 that comprises one or more jet or air hose for directing cooled air or cooled water toward a polymer impregnated carbon fiber 80. In some embodiments, the cooling stage 85 comprises a cooling component 86 that comprises a chamber (e.g., a box) through which polymer impregnated carbon fiber 80 can be pulled, wherein the chamber comprises an inlet for cooled air, an inlet for polymer impregnated carbon fiber 80, and an outlet for cooled, impregnated carbon fiber 90. In some embodiments, the one or more jet or air hose or the chamber is positioned after any shaping element (e.g., a shaping die, a pair of opposing surfaces or a set of free-turning rollers) in the direction of movement of the polymer impregnated carbon fiber 80. Thus, any of the above-mentioned components can be used in any combination.

Continuing with reference to FIG. 1, in some embodiments, the system further comprises a puller 120, positioned between the cooling stage the product processing stage 95 through which cooled, impregnated carbon fiber 90 is pulled after it exits the cooling stage. The puller 120 can be, for example, a set of power-driven rollers, which can be set to pull the carbon fiber tow through the system at a desired speed.

Referring to FIGS. 1 and 12, the components of the product processing stage 95 can vary depending upon the desired CFRP intermediated product 150. In some embodiments, when a continuous product is desired, the product processing stage 95 can comprise a winder. In some embodiments, the product processing stage 95 comprises a tape winder 130 or a spool 129. In some embodiments, when a discontinuous CFRP intermediate product 150 is desired, the product processing stage 95 comprises a chopper and/or a pelletizer. The product processing stage 95 can also include other components for packaging the discontinuous products in to bags or boxes.

### EXAMPLES

The following Examples have been included to provide guidance to one of ordinary skill in the art for practicing representative embodiments of the presently disclosed subject matter. In light of the present disclosure and the general level of skill in the art, those of skill can appreciate that the following Examples are intended to be exemplary only and that numerous changes, modifications, and alterations can be employed without departing from the scope of the presently disclosed subject matter.

A CFRP intermediate product was prepared from a 350 K textile grade carbon fiber tow using the method of the presently disclosed subject matter. The carbon fiber tow was impregnated with polypropylene homopolymer resin (PP3155 from ExxonMobil, Irving, Texas, United States of America) using the following processing parameters in an impregnation line using a coat-hanger die in a first impregnation stage and a pin die configured as described in Table 2, above, in a second impregnation stage. The processing parameters were as described in Table 1, above.

Flex strength and flex modulus of the CFRP intermediate samples can be measured as described in ASTM D790-17. Preliminary data was collected for five samples of the CFRP intermediate product. Sample dimensions are described in Table 3, below. Preliminary strength and modulus results are shown for the individual samples in Table 4, below.

TABLE 3
CFRP Sample Dimensions.

| | Average | Average | | Span |
|---|---|---|---|---|
| | Width | Thickness | Length | Length |
| Sample | (mm) | (mm) | (mm) | (mm) |
| 1 | 13.457 | 3.982 | 152.74 | 127.41 |
| 2 | 12.623 | 4.096 | 152.06 | 131.08 |
| 3 | 12.617 | 4.256 | 152.16 | 136.20 |
| 4 | 12.597 | 4.047 | 151.83 | 129.51 |
| 5 | 12.593 | 4.174 | 152.08 | 133.56 |

TABLE 4
CFRP Sample Flex Strength and Flex Modulus.

| | Midspan | Peak | Flex | | Flex |
|---|---|---|---|---|---|
| | deflection | Load | Strength | Slope | Modulus |
| Sample | (mm) | (N) | (MPa) | (N/mm) | (GPa) |
| 1 | 36.228 | 256.66 | 337.52 | 42.97 | 28.80 |
| 2 | 35.214 | 314.77 | 409.54 | 67.62 | 44.37 |
| 3 | 33.890 | 297.77 | 350.88 | 82.18 | 48.09 |
| 4 | 35.640 | 324.68 | 436.90 | 64.77 | 44.15 |
| 5 | 34.561 | 260.68 | 323.79 | 41.40 | 25.74 |

It will be understood that various details of the presently disclosed subject matter may be changed without departing from the scope of the presently disclosed subject matter. Furthermore, the foregoing description is for the purpose of illustration only, and not for the purpose of limitation.

1. A process for preparing a carbon fiber reinforced polymer (CFRP) intermediate product, wherein the CFRP intermediate product comprises carbon fiber and a polymeric matrix, the process comprising:
(a) spreading a carbon fiber tow to provide a spread carbon fiber tow;
(b) heating the spread carbon fiber tow to provide a heated spread carbon fiber tow;
(c) extruding a molten polymer resin through a first impregnation die, wherein said molten polymer resin is a molten thermoplastic or melt-processable thermosetting polymer resin corresponding to the polymeric matrix of the CFRP intermediate product, and wherein said first impregnation die comprises a chamber and an extrusion slit, wherein said first impregnation die is configured to extrude a sheet of molten polymer resin from said extrusion slit;
(d) impregnating the heated spread carbon fiber tow with molten polymer resin, wherein said impregnating comprises contacting the heated spread carbon fiber tow with the sheet of molten polymer resin, thereby providing a polymer impregnated carbon fiber tow; and
(e) cooling the polymer impregnated carbon fiber tow to provide a cooled, polymer impregnated carbon fiber.

2. The process of claim 1, wherein the carbon fiber tow comprises textile grade carbon fiber (TCF).

3. The process of claim 1, wherein the carbon fiber tow comprises about 100,000 or more carbon fiber filaments, optionally about 300,000 or more carbon fiber filaments, further optionally about 300,000 to about 600,000 carbon fiber filaments or about 350,000 to about 450,000 carbon fiber filaments.

4. The process of claim 1, wherein, prior to step (a), the carbon fiber tow is heated and/or tensioned.

5. The process of claim 1, wherein prior to step (a) the carbon fiber tow is treated to eliminate a sizing agent or agents.

6. The process of claim 1, wherein step (a) comprises passing the carbon fiber tow under tension over and/or under a spreader roller, thereby spreading carbon fiber filaments in the carbon fiber tow and providing a spread carbon fiber tow.

7. The process of claim 1, wherein heating the spread carbon fiber tow comprises heating the spread carbon fiber tow to about a melt temperature of the molten polymer resin corresponding to the polymeric matrix of the CFRP intermediate product.

8. The process of claim 1, wherein heating the spread carbon fiber tow comprises passing the spread carbon fiber tow over one or more heated bars or through an oven.

9. The process of claim 1, wherein the first impregnation die comprises a sheet or film extrusion die, optionally a coat hanger die.

10. The process of claim 1, wherein the sheet of molten polymer resin and the heated spread carbon fiber tow have about the same width.

11. The process of claim 1, wherein the extrusion slit is positioned in a curved end of the first impregnation die and wherein the heated spread carbon fiber tow is conformed to said curved end during said impregnating step.

12. The process of claim 1, wherein contacting the heated spread carbon fiber tow with the sheet of molten polymer resin provides a semi-impregnated carbon fiber tow and wherein step (d) further comprises mechanically contacting the semi-impregnated carbon fiber tow to provide the polymer impregnated carbon fiber tow, optionally wherein the mechanically contacting comprises passing the semi-impregnated carbon fiber tow through a series of pins to provide the polymer impregnated carbon fiber tow.

13. The process of claim 12, wherein the series of pins is configured in a second impregnation die, optionally wherein said second impregnation die is heated to a melt temperature of the molten polymer resin.

14. The process of claim 12, wherein the series of pins comprises a series of pin pairs and step (d) comprises passing the semi-impregnated carbon fiber tow over or under at least one pin of each pin pair in said series of pin pairs.

15. The process of claim 1, wherein the molten polymer resin comprises a resin corresponding to a thermoplastic polymer selected from the group consisting of a polyolefin, a polyamide, a polyimide, a polyaryletherketone, a polysulfone, a polyarylene sulfide, and a polyurethane.

16. The process of claim 1, wherein the molten polymer resin comprises a resin corresponding to a melt-processable thermoset polymer selected from the group consisting of an epoxy, a polyimide, and a polyester.

17. The process of claim 1, wherein the cooling comprises air cooling.

18. The process of claim 1, wherein the cooling is performed while maintaining the polymer impregnated carbon fiber tow in a tape or ribbon geometry.

19. The process of claim 1, wherein the cooled, polymer impregnated carbon fiber is pulled through a puller device following step (e) to maintain a desired speed and/or tension.

20. The process of claim 1, further comprising step (f), wherein step (f) comprises further processing the cooled, polymer impregnated carbon fiber, optionally wherein step (f) comprises feeding the cooled, polymer impregnated carbon fiber onto a spool or a tape winder or wherein step (f) comprises pelletizing or chopping the cooled, polymer impregnated carbon fiber.

21. The process of claim 1, wherein the CFRP intermediate product comprises between about 30 weight % carbon fiber and about 70 weight % carbon fiber.

22. The CFRP intermediate product prepared according to the process of claim 1.

23. A system for preparing a carbon fiber reinforced polymer (CFRP) intermediate product, wherein the CFRP intermediate product comprises carbon fiber and a polymeric matrix, said polymeric matrix comprising a thermoplastic polymeric matrix or a thermoset polymeric matrix of a melt-processable thermosetting polymer resin, said system comprising:
(i) a carbon fiber tow feed roll;
(ii) a fiber spreading stage configured to receive carbon fiber tow from the carbon fiber tow feed roll and spread said carbon fiber tow, optionally wherein the fiber spreading stage comprises a spreader roller configured to spread the carbon fiber tow to a desired width, further optionally wherein the spreader roller is a bowed spreader roller;
(iii) a pre-heating stage configured to receive a spread carbon fiber tow from the fiber spreading stage and to heat the spread carbon fiber tow to a temperature to match a melt temperature of a molten polymer resin corresponding to the polymeric matrix of the CFRP intermediate product;
(iv) a first impregnation stage configured to receive the heated carbon fiber tow from the pre-heating stage, said first impregnation stage comprising (1) a first impregnation die and (2) an extruder or a polymer resin feed tube, wherein said first impregnation die comprises a chamber and an extrusion slit, wherein said extruder or polymer resin feed tube is configured to supply molten polymer resin corresponding to the polymeric matrix of the CFRP intermediate product to the chamber of the first impregnation die and wherein the extrusion slit is configured to extrude a sheet of molten polymer resin onto a surface of carbon fiber tow received from the pre-heating stage;
(v) an optional second impregnation stage configured to receive carbon fiber tow from the first impregnation stage, said second impregnation stage configured such that carbon fiber tow received from the first impregnation stage is mechanically contacted as it passes through the second impregnation stage, optionally wherein the second impregnation stage comprises a series of pins configured such that the carbon fiber tow passes over or under a plurality of pins in the series of pins, further optionally wherein said series of pins are heated or enclosed in a heated body;
(vi) a cooling stage, positioned to receive a polymer impregnated carbon fiber tow from the first or second impregnation stage, wherein the polymer impregnated carbon fiber tow is cooled; and
(vii) an optional product processing stage, positioned to receive cooled, polymer impregnated carbon fiber after it exits the cooling stage and wherein the cooled, polymer impregnated carbon fiber is processed into a desired form of the CFRP intermediate product.

24. The system of claim 23, further comprising one or more tensioning roll configured between the carbon fiber tow feed roll and the fiber spreading stage.

25. The system of claim 23, further comprising one or more heated bars configured between the carbon fiber tow feed roll and the fiber spreading stage.

26. The system of claim 23, wherein the extrusion slit is positioned in an end of the first impregnation die having a curved outer surface and wherein the first impregnation stage is configured so that carbon fiber tow passing through the first impregnation stage conforms to the curved outer surface.

27. The system of claim 23, wherein the series of pins in the second impregnation stage comprises a series of pin pairs, and wherein carbon fiber tow received from the first impregnation stage passes over or under at least one pin of each of said series of pin pairs, optionally in a path comprising a least two different break angles.

28. The system of claim 23, wherein cooling stage (vi) comprises a series of at least two free-turning rollers through which the polymer impregnated carbon fiber tow can be pulled.

29. The system of claim 23, wherein cooling stage (vi) comprises one or more jet for directing cooled air or cooled water toward the polymer impregnated carbon fiber tow.

30. The system of claim 23, wherein cooling stage (vi) comprises a cooling chamber through which polymer impregnated carbon fiber tow can be pulled, wherein the cooling chamber comprises an inlet for cooled air, an inlet for a polymer impregnated carbon fiber tow, and an outlet for the cooled, polymer impregnated carbon fiber.

31. The system of claim 23, wherein cooling stage (vi) comprises a shaping die for forming a rod-shaped material from the polymer impregnated carbon fiber tow.

32. The system of claim 23, further comprising a puller, positioned between cooling stage (vi) and product processing stage (vii) through which cooled, polymer impregnated carbon fiber is pulled after it exits cooling stage (vi).

33. The system of claim 23, wherein product processing stage (vii) comprises a tape winder, a spool or a creel.

34. The system of claim 23, wherein product processing stage (vii) comprises a chopper and/or a pelletizer.

35. A carbon fiber reinforced polymer (CFRP) intermediate product, wherein said CFRP comprises fully impregnated textile grade carbon fiber.

36. The CFRP of claim 35, wherein the CFRP intermediate product is a CFRP tape.

37. The CFRP of claim 35, wherein the CFRP intermediate product comprises a thermoplastic polymer matrix or a matrix formed from a melt-processable thermosetting polymer.
